(19) United States
(12) Patent Application Publication
(10) Pub. No.: US 2017/0280197 A1
(43) Pub. Date: Sep. 28, 2017

(54) INFORMATION RECOMMEND SYSTEM, INFORMATION RECOMMEND METHOD AND NON-TRANSITORY COMPUTER-READABLE STORAGE MEDIUM

(71) Applicant: INSTITUTE FOR INFORMATION INDUSTRY, TAIPEI (TW)

(72) Inventors: Sheng-Chang CHEN, Taipei City (TW); Rong-Sheng WANG, Taipei City (TW); Shu-Ming HSU, New Taipei City (TW); Hao-Cheng WANG, New Taipei City (TW); Jhuo-Syun LI, Taichung City (TW); Shih-Chun CHOU, Taipei City (TW)

(21) Appl. No.: 15/200,004

(22) Filed: Jul. 1, 2016

(30) Foreign Application Priority Data
Mar. 23, 2016 (TW) 105109035

(51) Int. Cl. H04N 21/466; H04N 21/278; G06F 17/30; H04N 21/81; H04N 5/44; H04L 29/08; H04N 21/45

(52) U.S. Cl. CPC H04N 21/4668; H04L 67/306; H04N 21/278; H04N 21/4532; H04N 21/812; H04N 5/44; G06F 17/30525; G06F 17/30528; G06F 17/3097; H04N 2005/4412

(57) ABSTRACT

An information recommend system includes an information recommend device. The information recommend device is configured to store a operation model and a recommendation model. The operation model is composed of a plurality of operation mode data, and the recommendation model is composed of detailed data of a plurality of multimedia data. The information recommend device is further configured to receive a plurality of real-time viewing data, determine a real-time operation mode according to the real-time viewing data and the operation model, and determine recommending multimedia data and a time point for recommending form the detailed data of the multimedia data according to the real-time operation mode and the recommendation model.

### RELATED APPLICATIONS

This application claims priority to Taiwan Application Serial Number 105109035, filed Mar. 23, 2016, which is herein incorporated by reference.

### BACKGROUND

Technical Field

The present invention relates to recommendation technology. More particularly, the present invention relates to an information recommend system, an information recommend method and a non-transitory computer-readable storage medium.

Description of Related Art

Recently, television (TV) becomes one of entertainment that people usually choose in daily life. When a viewer watches TV, advertisements are often broadcast between programs. However, methods of broadcasting the advertisements are mostly fixed, and the advertisements are hard to get the viewer's interest. Therefore, advertising effect is very limited.

### SUMMARY

In order to effectively improve advertising effect, an aspect of the present disclosure provides an information recommend system that includes an information recommend device. The information recommend device is configured to store an operation model and a recommendation model. The operation model is composed of a plurality of operation mode data, and the recommendation model is composed of detailed data of a plurality of multimedia data. The information recommend device is further configured to receive a plurality of real-time viewing data, to determine a real-time operation mode according to the real-time viewing data and the operation model, and to determine recommending multimedia data and a time point for recommending from the detailed data of the multimedia data according to the real-time operation mode and the recommendation model.

In an embodiment of the present disclosure, the information recommend device is a set-top box (STB), and the information recommend system further includes a database. The database is configured to store the operation model, the recommendation model and the detailed data of the multimedia data, and to communicatively connect to the information recommend device through a communication network to send the operation model and the recommendation model to the information recommend device for storage and updating.

In an embodiment of the present disclosure, the information recommend system further includes a processing device. The processing device is connected to the database and communicatively connected to the information recommend device through the communication network. The processing device is configured to receive the real-time viewing data from the information recommend device to update the operation model and the recommendation model in the database.

In an embodiment of the present disclosure, the information recommend device further includes a storage unit. The storage unit is configured to store the operation model, the recommendation model and a plurality of viewer profiles. The information recommend device is further configured to determine a real-time viewer profile according to the real-time viewing data, and then to determine the recommending multimedia data and the time point for recommending from the detailed data of the multimedia data according to the real-time operation mode, the real-time viewer profile and the recommendation model.

In an embodiment of the present disclosure, the operation mode data in the operation model is respectively corresponding to a plurality of feature data of operation mode. The information recommend device is further configured to generate a plurality of feature data according to the real-time viewing data, and to determine the real-time operation mode according to the feature data and the operation model.

In an embodiment of the present disclosure, the detailed data of the multimedia data are categorical data of the multimedia data, broadcast channels and broadcast times. The real-time viewing data includes a current time, and the information recommend device determines the recommending multimedia data according to the current time and the broadcast times of the multimedia data.

In an embodiment of the present disclosure, the information recommend system further includes a remote control for a viewer to operate. The remote control configured to generate the real-time viewing data and to send the real-time viewing data to the information recommend device. The remote control includes a recommend button for the viewer. The recommend button is configured to select whether to display the recommending multimedia data on a display.

In an embodiment of the present disclosure, the information recommend system further includes a display, which is configured to provide an operation interface to display the recommending multimedia data.

Another aspect of the present disclosure provides an information recommend method adaptable to an information recommend device. The information recommend method includes steps as follows. A plurality of real-time viewing data are received. A real-time operation mode is determined according to the real-time viewing data and an operation model. The operation model is composed of a plurality of operation mode data. A recommending multimedia data and a time point for recommending are determined from detailed data of a plurality of multimedia data according to the real-time operation mode and a recommendation model. The recommendation model is composed of the detailed data of the multimedia data.

In an embodiment of the present disclosure, the information recommend device is a set-top box (STB). The operation model, the recommendation model and the detailed data of the multimedia data are stored by a database. The database is communicatively connected to the information recommend device through a communication network to send the operation model and the recommendation model to the information recommend device for storage and updating

In an embodiment of the present disclosure, the database is connected, and the information recommend device is communicatively connected through the communication network by a processing device. The real-time viewing data are received from the information recommend device by the processing device to update the operation model and the recommendation model in the database.

In an embodiment of the present disclosure, the information recommend device further stores a plurality of viewer profile. A real-time viewer profile is determined according to the real-time viewing data, and then the recommending multimedia data and the time point for recommending are determined from the detailed data of the multimedia data according to the real-time operation mode, the real-time viewer profile and the recommendation model.

In an embodiment of the present disclosure, the operation mode data in the operation model is respectively corresponding to a plurality of feature data of operation mode. A plurality of feature data are generated according to the real-time viewing data. The real-time operation mode is determined according to the feature data and the operation model.

In an embodiment of the present disclosure, the recommending multimedia data is determined according to the current time and the broadcast times of the multimedia data. The detailed data of the multimedia data are categorical data of the multimedia data, broadcast channels and broadcast times. The real-time viewing data includes a current time.

In an embodiment of the present disclosure, the real-time viewing data is generated by a remote control for a viewer to operate. The recommending multimedia data are selected whether to be displayed on a display by a recommend button of the remote control for the viewer.

In an embodiment of the present disclosure, an operation interface is provided to display the recommending multimedia data by a display.

Another aspect of the present disclosure provides a non-transitory computer-readable storage medium storing a program that is loaded and executed by a computer, performs an information recommend method. The information recommend method includes steps as follows. A plurality of real-time viewing data are received. A real-time operation mode is determined according to the real-time viewing data and an operation model. The operation model is composed of a plurality of operation mode data. A recommending multimedia data and a time point for recommending are determined from detailed data of a plurality of multimedia data according to the real-time operation mode and a recommendation model. The recommendation model is composed of the detailed data of the multimedia data.

In conclusion, the present disclosure can recommend the multimedia information that is close to the user's preference to the user at an appropriate time point. Therefore, advertising effect is greatly improved without disturbance to the user.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of an information recommend system according to an embodiment of the present disclosure;

FIG. 2 is a schematic diagram of another information recommend system according to an embodiment of the present disclosure;

FIG. 3 is a flow chart of an information recommend method according to an embodiment of the present disclosure; and

FIG. 4 is a flow chart of another information recommend method according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled,” and the term “connected” may be termed as “electrically connected.” “Coupled” and “connected” may also be used to indicate that two or more elements cooperate or interact with each other.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

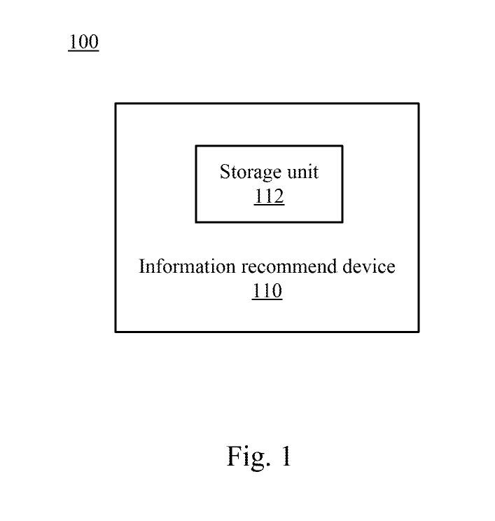

FIG. 1 is a schematic diagram of an information recommend system 100 according to an embodiment of the present disclosure. The information recommend system 100 includes an information recommend device 110, such as a set-top box (STB) or a special device, which may be connected to a television (TV) or another multimedia broadcast device. The information recommend device 110 may have a storage unit or a database configured to store an operation model and a recommendation model. The aforementioned operation model includes a plurality of operation mode data (e.g., watching mode, browsing mode, idle mode, etc.), and the recommendation model includes detailed data (e.g., names of multimedia, contents of multimedia, categories of multimedia, channel data of broadcast multimedia data, broadcast times of multimedia data, advertisements, etc.) of a plurality of multimedia data.

When a user watches a television program and operates a remote control, a plurality of real-time viewing data (e.g., the data about a frequency of pressing a button, a preferred button, operating method of a certain button and so on when the remote control is operated) are generated and the information recommend device 110 is configured to receive the plurality of real-time viewing data. Then, the information recommend device 110 determines a real-time operation mode of watching TV for the user according to the real-time viewing data and the operation model, and determines a recommending multimedia data and a time point for recommending from the detailed data of the multimedia data according to the real-time operation mode and the recommendation model. In a specific embodiment, the detailed data of the multimedia data are categorical data of the multimedia data, broadcast channels (e.g., a self-operated channel of a channel supplier) and broadcast times, and the real-time viewing data includes a current time when the user operates the remote control. In the present embodiment, the information recommend device 110 determines the recommending multimedia data according to the current time and the broadcast times of the multimedia data to provide the recommending multimedia data to the user at a particular time point for recommending. However, the present disclosure is not limited to the embodiment. Therefore, the information recommend system 100 can effectively provide advertisements and avoid disturbing the user watching the programs.

For example, the real-time operation mode includes a watching mode, a browsing mode and an idle mode. The watching mode indicates that the user is steadily watching a program from a particular channel, the browsing mode indicates that the user continuously switches channels and searches for a desired TV program, and the idle mode indicates that the user stays tuned to another channel over a certain time period without any operating signal and may walk away from the TV.

Regarding to the time point for recommending, in an embodiment, when the real-time operation mode of the user is the browsing mode, the information recommend device 110 may directly push the recommending multimedia data to recommend the user. The user may operate the remote control 240 to select whether the recommending multimedia data displays on a display 250 (e.g., a TV or a multimedia player).

As a result, the information recommend system 100 can provide the recommending multimedia data to the user at an appropriate time point according to an operation mode of currently watching a video channel by the user (i.e., the real-time operation mode). Therefore, the user can receive the recommending multimedia data without disturbance to improve advertising effect.

In an embodiment, the information recommend device 110 includes a storage unit 112 that is configured to store the operation model, the recommendation model and a plurality of viewer profile.

The aforementioned viewer profiles indicate modes of users when watching TV programs, and it is not limited to a single user or many users. In other words, the same user can have different viewer profiles at different time points, or many users may have the same viewer profile. The viewer profiles depend on ways that users operate a remote control device in real-time and/or program contents watched by the users, and the viewer profiles are corresponding to diverse user preferences (e.g., preferences for channels, preferences for TV program types, etc).

In a further embodiment, the information recommend device 110 is configured to determine a real-time viewer profile according to the real-time viewing data to reflect the user's preference (e.g., preferences for channels, program categories, etc.) Then, the information recommend device 110 determines the recommending multimedia data and the time point for recommending from the detailed data of the multimedia data according to the real-time operation mode, the real-time viewer profile and the recommendation model. Specifically, the information recommend device 110 determines the recommending multimedia data that is related to the user's preference through the recommendation model according to the real-time viewer profile, the categorical data and the broadcast channels in the detailed data of the multimedia data. Therefore, the recommending multimedia data determined by the information recommend device 110 according to the real-time viewer profile is closer to the user's preference, and advertising effect can be further improved.

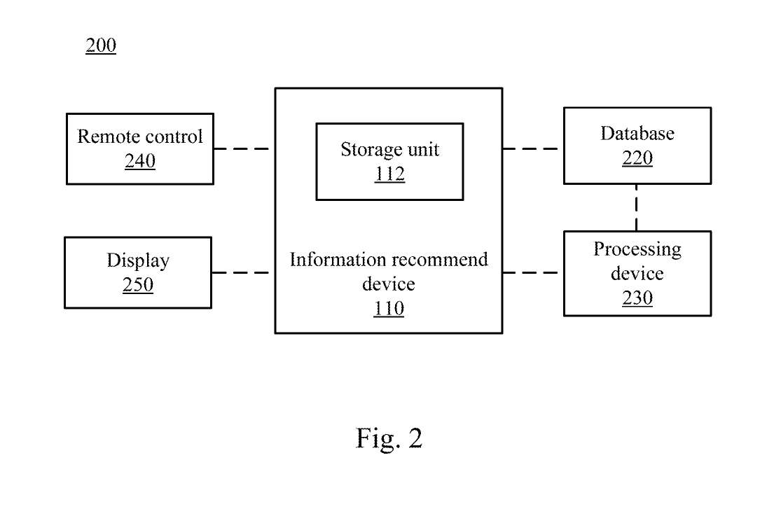

FIG. 2 is a schematic diagram of another information recommend system 200 according to an embodiment of the present disclosure. The information recommend system 200 has substantially the same configuration as the information recommend system 100 in FIG. 1 except for a database 220, a processing device 230, a remote control 240 and a display 250.

In an embodiment, the information recommend system 200 includes a database 220. The database 220 is configured to store the operation model, the recommendation model and the detailed data of the multimedia data, and to communicatively connect to the information recommend device 110 through a communication network. The database 220 sends the operation model and the recommendation model to the information recommend device 110 for storage and updating.

In an embodiment, the information recommend system 200 includes a remote control 240 and a display 250. The remote control 240 is for a user (e.g., a viewer) to operate and is configured to generate the real-time viewing data and to send the real-time viewing data to the information recommend device 110. The remote control 240 includes a recommend button that can be used by the viewer to select whether to display the recommending multimedia data on the display 250 (e.g., a TV). The display 250 is configured to provide an operation interface to display the recommending multimedia data. When the viewer doesn't want to be disturbed during the programs, the viewer may determine that the display 250 doesn't display the recommending multimedia data through the recommend button. When the viewer is interested in multimedia data content, the viewer may determine that the display 250 displays the recommending multimedia data through the recommend button. Therefore, the viewer can independently determine whether the recommending multimedia data is displayed on the display 250 to avoid disturbing watching the programs.

In an embodiment, the information recommend system 200 includes a processing device 230 that is connected to the database 220 and communicatively connected to the information recommend device 110 through the communication network. The processing device 230 is configured to execute a viewer data analysis process according to the real-time viewing data received by the information recommend device 110 in the user's house to update the operation model and the recommendation model in the database 220. Then, the database 220 may send the operation model and the recommendation model to the information recommend device 110 for storage and updating. Therefore, the processing device 230 can correct the operation model and the recommendation model according to all of the real-time viewing data generated by the remote control that is operated by the user to maintain accuracy of determining the real-time operation mode and recommending the multimedia data.

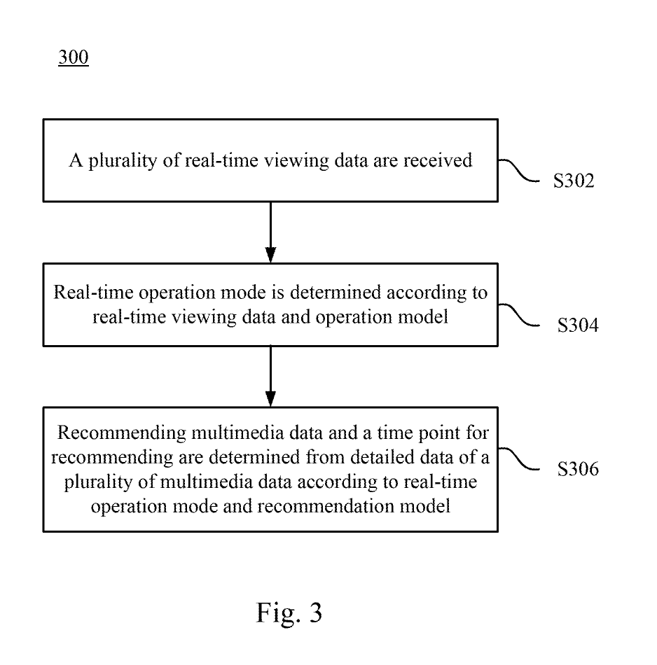

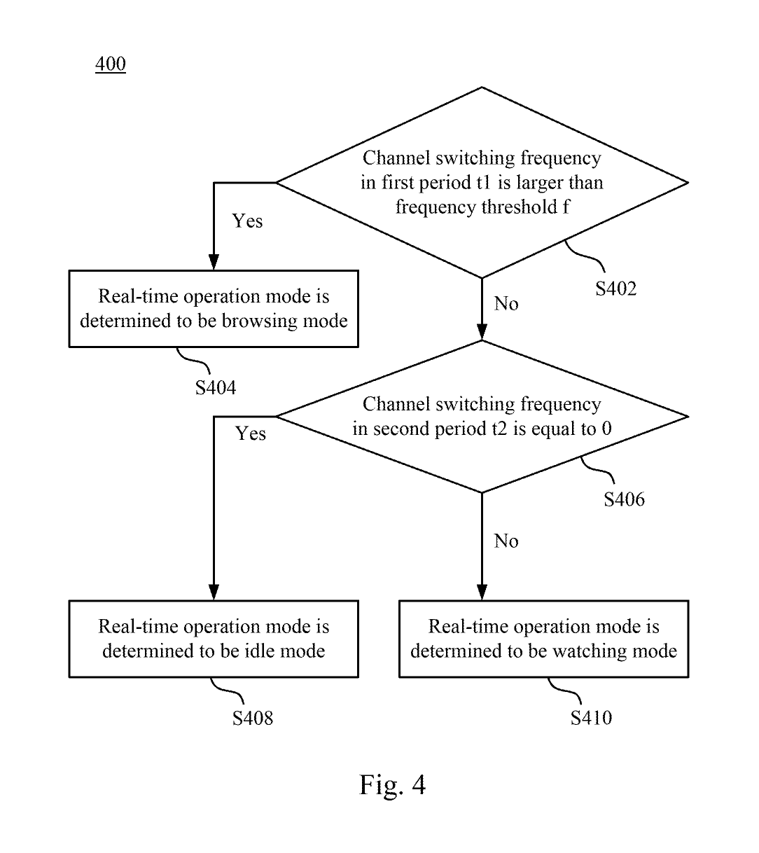

FIGS. 3 and 4 are flow charts of information recommend methods 300 and 400 according to some embodiments of the present disclosure. The information recommend method 300 includes steps S302-S306, the information recommend method 400 includes steps S402-S410, and the information recommend methods 300 and 400 can be applied to information recommend systems 100 and 200 as shown in FIGS. 1 and 2. The information recommend methods 300 and 400 can be implemented as computer programs stored in a non-transitory computer-readable medium, which is loaded by a computer to make the computer execute the multi-class object classifying method. The non-transitory computer-readable medium can be read only memory (ROM), flash memory, soft disk, hard disk, optical disk, pen drive, magnetic tape, network accessible database, or other computer-readable medium with the same function that are obvious for those skilled in the art. However, those skilled in the art should understand that the mentioned steps in the present embodiment are in an adjustable execution sequence according to the actual demands except for the steps in a specially described sequence, and even the steps or parts of the steps can be executed simultaneously.

In step S302, a plurality of real-time viewing data are received.

In step S304, a real-time operation mode is determined according to the real-time viewing data and the operation model. The operation model is composed of a plurality of operation mode data.

In step S306, recommending multimedia data and a time point for recommending are determined from detailed data of a plurality of multimedia data according to the real-time operation mode and the recommendation model. The recommendation model is composed of the detailed data of the multimedia data.

In order to describe feature data, in an embodiment, the information recommend device 110 generates a plurality of feature data (e.g., channel switching frequencies f1 and f2) according to the real-time viewing data. Then, the information recommend device 110 determines the real-time operation mode of the user according to the feature data through the operation model. The operation mode data in the operation model respectively corresponds to a plurality of feature data of operation mode. For example, the feature data of the operation mode may be a condition (e.g., channel switching frequency) corresponding to each of the operation mode data, and be used to determine the current real-time operation mode of the user.

TABLE 1

| | Channel switching | Channel switching | |
|---|---|---|---|
| | frequency f1 in first | frequency f2 in second | Real-time |
| | period t1 | period t2 | operation mode |
| Data 1 | 0/s | 0/s | Idle |
| Data 2 | 0.2/s | 0.1/s | Browsing |
| Data 3 | 0.02/s | 0.01/s | Watching |
| Data 4 | 0.033/s | 0.017/s | Watching |
| Data 5 | 0.1/s | 0.05/s | Browsing |

Reference is made to table 1 and FIG. 4, in another embodiment, the first period t1 is set as 1 minute, the second period t2 is set as 10 minutes, and data 1-data 5 indicate five real-time viewing data received by the information recommend device 110 from the remote control 240. The information recommend device 110 generates feature data, such as a channel switching frequency f1 in the first period t1 and a channel switching frequency f2 in the second period t2, according to the real-time viewing data (i.e., the data 1-data 5). If the information recommend device 110 determines that the channel switching frequency f1 is larger than a frequency threshold f (e.g., 0.05/s) in step S402, it indicates that the user frequently switches channels, and then the information recommend device 110 determines that the real-time operation mode of the user is a browsing mode (e.g., data 2, data 5) in step S404. In contrast, if the information recommend device 110 determines that the channel switching frequency f1 is smaller than the frequency threshold f in step S402, it indicates that the user doesn't often switch channels, and then the information recommend device 110 determines whether the channel switching frequency is equal to 0 in step S406. If the information recommend device 110 determines that the channel switching frequency f2 is equal to 0 in step S406, it indicates that the user stays tuned to a particular channel for a certain time, and then the information recommend device 110 determines that the real-time operation mode of the user is an idle mode (e.g., data 1) in step S408. In contrast, if the information recommend device 110 determines that the channel switching frequency f2 is not equal to 0 in step S406, it indicates that the user still switches channels, and then the information recommend device 110 determines that the real-time operation mode of the user is a watching mode (e.g., data 3, data 4) in step S410. The first period t1, the second period t2, the frequency threshold f may be designed according to actual demand and not limited to the values in the embodiment.

In order to reduce disturbance to the user, the information recommend device 110 determines timing for pushing the recommending multimedia data according to the real-time operation mode of the user. For example, when the user is in the browsing mode, the information recommend device 110 directly pushes the recommending multimedia data. When the user is in the watching mode, the information recommend device 110 pushes the recommending multimedia data in an advertisement time. When the user is in the idle mode, it indicates that the user may walk away from the TV and the information recommend device 110 stops pushing the recommending multimedia data or pushes the recommending multimedia data in the advertisement time. The actions executed according to the real-time operation mode by the information recommend device 110 may be adjusted based on actual situations and are not limited to the aforementioned actions.

In an embodiment, the information recommend device 110 may be implemented as a set-top box (STB). The processing device 230 may be implemented as a computer. The storage unit 112 may be implemented as a flash memory, a hard disk or another storage device that can be thought by those skilled in the art. The database 220 can be stored in a storage device, such as a hard disk, any non-transitory computer readable storage medium, or a database accessible from network. Those of ordinary skill in the art can think of the appropriate implementation of the database 220 without departing from the spirit and scope of the present disclosure.

In conclusion, the present disclosure can recommend the multimedia information that is close to the user's preference to the user at an appropriate time point. Therefore, advertising effect is greatly improved without disturbance to the user.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An information recommend system, comprising:
an information recommend device, configured to store an operation model and a recommendation model, wherein the operation model is composed of a plurality of operation mode data, and the recommendation model is composed of detailed data of a plurality of multimedia data;
wherein the information recommend device is further configured to receive a plurality of real-time viewing data from a remote control, to generate a plurality of channel switching frequencies according to the real-time viewing data, to determine a real-time operation mode according to the channel switching frequencies and the operation model, and to determine a recommending multimedia data and a time point for recommending form the detailed data of the multimedia data according to the real-time operation mode and the recommendation model, wherein the recommending multimedia data comprises an advertisement,
wherein the channel switching frequencies comprises a first channel switching frequency in a first period and a second channel switching frequency in a second period, and the first period is shorter than the second period,
wherein the information recommend device determines that the real-time operation mode is a browsing mode and directly pushes the recommending multimedia data if the first channel switching frequency is larger than a frequency threshold,
wherein the information recommend device determines that the real-time operation mode is an idle mode and stops pushing the recommending multimedia data or pushes the recommending multimedia data in an advertisement time if the first channel switching frequency is not larger than the frequency threshold and the second channel switching frequency is equal to 0,
wherein the information recommend device determines that the real-time operation mode is a watching mode and pushes the recommending multimedia data in the advertisement time if the first channel switching frequency is not larger than the frequency threshold and the second channel switching frequency is not equal to 0.

2. The information recommend system of claim 1, wherein the information recommend device is a set-top box (STB), and the information recommend system further comprises:
a database, configured to store the operation model, the recommendation model and the detailed data of the multimedia data, and to communicatively connect to the information recommend device through a communication network to send the operation model and the recommendation model to the information recommend device for storage and updating.

3. The information recommend system of claim 2, further comprising:
a processing device, connected to the database and communicatively connected to the information recommend device through the communication network, wherein the processing device is configured to receive the real-time viewing data from the information recommend device to update the operation model and the recommendation model in the database.

4. The information recommend system of claim 1, wherein the information recommend device further comprises:
a storage unit, configured to store the operation model, the recommendation model and a plurality of viewer profiles, wherein the information recommend device is further configured to determine a real-time viewer profile according to the real-time viewing data, and then to determine the recommending multimedia data and the time point for recommending from the detailed data of the multimedia data according to the real-time operation mode, the real-time viewer profile and the recommendation model.

5. (canceled)

6. The information recommend system of claim 1, wherein the detailed data of the multimedia data are categorical data of the multimedia data, broadcast channels and broadcast times, the real-time viewing data comprises a current time, and the information recommend device determines the recommending multimedia data according to the current time and the broadcast times of the multimedia data.

7. The information recommend system of claim 1, wherein the remote control is for a viewer to operate, configured to generate the real-time viewing data and to send the real-time viewing data to the information recommend device, wherein the remote control comprises:
a recommend button for the viewer, configured to select whether to display the recommending multimedia data on a display.

8. The information recommend system of claim 1, further comprising:
a display, configured to provide an operation interface to display the recommending multimedia data.

9. An information recommend method adaptable to an information recommend device, comprising:
receiving a plurality of real-time viewing data from a remote control;
generating a plurality of channel switching frequencies according to the real-time viewing data, wherein the channel switching frequencies comprises a first channel switching frequency in a first period and a second channel switching frequency in a second period, and the first period is shorter than the second period;
determining a real-time operation mode according to the channel switching frequencies and an operation model, wherein the operation model is composed of a plurality of operation mode data;
determining a recommending multimedia data and a time point for recommending from detailed data of a plurality of multimedia data according to the real-time operation mode and a recommendation model, wherein the recommendation model is composed of the detailed data of the multimedia data, wherein the recommending multimedia data comprises an advertisement
determining that the real-time operation mode is a browsing mode and directly pushing the recommending multimedia data if the first channel switching frequency is larger than a frequency threshold;
determining that the real-time operation mode is an idle mode and stopping pushing the recommending multimedia data or pushing the recommending multimedia data in an advertisement time if the first channel switching frequency is not larger than the frequency threshold and the second channel switching frequency is equal to 0; and
determining that the real-time operation mode is a watching mode and pushing the recommending multimedia data in the advertisement time if the first channel switching frequency is not larger than the frequency threshold and the second channel switching frequency is not equal to 0.

10. The information recommend method of claim 9, wherein the information recommend device is a set-top box (STB), and the information recommend method further comprises:
by a database, storing the operation model, the recommendation model and the detailed data of the multimedia data, and communicatively connecting to the information recommend device through a communication network to send the operation model and the recommendation model to the information recommend device for storage and updating.

11. The information recommend method of claim 10, further comprising:
by a processing device, connecting to the database, communicatively connecting to the information recommend device through the communication network, and receiving the real-time viewing data from the information recommend device to update the operation model and the recommendation model in the database.

12. The information recommend method of claim 9, wherein the information recommend device further stores a plurality of viewer profile, and the information recommend method further comprises:
determining a real-time viewer profile according to the real-time viewing data, and then determining the recommending multimedia data and the time point for recommending from the detailed data of the multimedia data according to the real-time operation mode, the real-time viewer profile and the recommendation model.

13. (canceled)

14. The information recommend method of claim 9, further comprising:
determining the recommending multimedia data according to the current time and the broadcast times of the multimedia data, wherein the detailed data of the multimedia data are categorical data of the multimedia data, broadcast channels and broadcast times, the real-time viewing data comprises a current time.

15. The information recommend method of claim 9, further comprising:
by the remote control for a viewer to operate, generating the real-time viewing data; and
by a recommend button of the remote control for the viewer, selecting whether to display the recommending multimedia data on a display.

16. The information recommend method of claim 9, further comprising:
by a display, providing an operation interface to display the recommending multimedia data.

17. A non-transitory computer-readable storage medium storing a program that is loaded and executed by a computer, performs an information recommend method, and the information recommend method comprises:
receiving a plurality of real-time viewing data from a remote control;
generating a plurality of channel switching frequencies according to the real-time viewing data, wherein the channel switching frequencies comprises a first channel switching frequency in a first period and a second channel switching frequency in a second period, and the first period is shorter than the second period;
determining a real-time operation mode according to the channel switching frequencies and an operation model, wherein the operation model is composed of a plurality of operation mode data;
determining a recommending multimedia data and a time point for recommending from detailed data of a plurality of multimedia data according to the real-time operation mode and a recommendation model, wherein the recommendation model is composed of the detailed data of the multimedia data wherein the recommending multimedia data comprises an advertisement;
determining that the real-time operation mode is a browsing mode and directly pushing the recommending multimedia data if the first channel switching frequency is larger than a frequency threshold;
determining that the real-time operation mode is an idle mode and stopping pushing the recommending multimedia data or pushing the recommending multimedia data in an advertisement time if the first channel switching frequency is not larger than the frequency threshold and the second channel switching frequency is equal to 0; and
determining that the real-time operation mode is a watching mode and pushing the recommending multimedia data in the advertisement time if the first channel switching frequency is not larger than the frequency threshold and the second channel switching frequency is not equal to 0.

18-20. (canceled)
